(19) United States
(12) Patent Application Publication
(10) Pub. No.: US 2025/0289985 A1
(43) Pub. Date: Sep. 18, 2025

(54) HIGH-STRENGTH ADHESIVES FROM SUSTAINABLE COMPONENTS

(71) Applicant: PURDUE RESEARCH FOUNDATION, West Lafayette, IN (US)

(72) Inventors: Jonathan Wilker, Westfield, IN (US); Clayton Reyes Westerman, Leo, IN (US); Bradley Charles McGill, Avon, IN (US)

(21) Appl. No.: 18/862,945

(22) PCT Filed: May 5, 2023
(86) PCT No.: PCT/US2023/066649

§ 371 Date: Nov. 4, 2024

Related U.S. Application Data
(60) Provisional application No. 63/338,465, filed on May 5, 2022.

(51) Int. Cl. C09J 163/00; C08G 59/32; C08G 59/62

(52) U.S. Cl. CPC C09J 163/00; C08G 59/32; C08G 59/621; C08G 59/625

(57) ABSTRACT

A high-strength adhesive composition comprising components such as (i) an epoxidized oil, (ii) a nucleophile, and (iii) a phenolic compound derived from sustainably sourced, low-cost biological materials available on a large scale; its use; and a method of manufacturing.

### CROSS-REFERENCE TO RELATED APPLICATION

This application claims priority to U.S. provisional patent application No. 63/338,465, which was filed May 5, 2022, and which is hereby incorporated by reference in its entirety.

### STATEMENT OF GOVERNMENT SUPPORT

This invention was made with government support under N00014-19-1-2342 awarded by the Office of Naval Research. The government has certain rights in the invention.

### TECHNICAL FIELD

The present disclosure relates to high-strength adhesives manufactured using sustainable components. In particular, the disclosure relates to high-strength adhesives comprising bio-based materials, which enhance recycling and enable a sustainable materials ecosystem.

### BACKGROUND

This section introduces aspects that may help facilitate a better understanding of the disclosure. Accordingly, these statements are to be read in this light and are not to be understood as admissions about what is or is not prior art.

Most consumer products, from electronics to furniture, are held together with adhesives. High performance, versatility, and low cost are characteristics of modern glues. However, such traits also give rise to several environmental drawbacks. These materials are derived from petroleum, which creates permanent bonds, lacks chemical degradation, and is toxic. Due to this non-natural sourcing of adhesives, most components cannot be separated for recycling. An inability to degrade bonds disallows substrate separation, prevents recycling, and forces products to landfills. These discarded adhesive resins further contribute to the problem of ocean microplastics. Toxicity can also be a concern with, for example, the binders in plywood emitting carcinogenic formaldehyde. Society is awash in single-use products and packaging. Biomimetic chemistry, inspired by the adhesives of shellfish, provides the required cross-linking. Biologically sourced adhesives may provide a needed path toward a sustainable materials ecosystem.

Cost and performance are perpetual issues with bio-based alternative adhesives when compared to modern materials. In terms of bio-adhesives, availability is a further hindrance to sustainability. The components of bio-based materials are not easy to manufacture at large scales. Thus, they are not adopted by industries.

Thus, there is an unmet need for a high-strength adhesive that can be easily recycled, safe for the ecosystem, low-cost, manufactured using bio-based materials, and readily available on a large scale. It is an object of the present disclosure to provide such an adhesive. This and other objects and advantages, as well as inventive features, will be apparent from the detailed description provided herein.

### SUMMARY

Provided is an adhesive composition comprising (i) an epoxidized oil (EO), (ii) a nucleophile, and (iii) a phenolic compound.

The epoxidized oil can be any suitable epoxidized oil obtained from a sustainable source. In some embodiments, the sustainable source can be a plant or a vegetable. In some embodiments, the epoxidized oil is epoxidized soy oil.

The nucleophile can be a compound comprising a moiety selected from the group consisting of an acid, an alcohol, an amine, and a thiol. In some embodiments, the nucleophile can be selected from fumaric acid, glycerol, malic acid, succinic acid, or a combination thereof. In some embodiments, the nucleophile is malic acid.

The phenolic compound can be selected from catechol, gallic acid, gallol, lignin, tannic acid, or a combination thereof. In some embodiments, the phenolic compound is tannic acid.

In some embodiments, the adhesive composition can optionally further comprise a solvent. Examples of the solvent include, but are not limited to, alcohol, water, chloroform, dichloromethane, dimethyl sulfoxide, and dimethyl formamide. In some embodiments, the solvent can be alcohol, such as ethanol or methanol.

In some embodiments, the EO, nucleophile, and phenolic compound can be present in a mass ratio from about 1:0.1:0.1 to about 1:10:10.

In some embodiments, an adhesive composition consisting essentially of (i) epoxidized soy oil (ESO), (ii) malic acid, (iii) tannic acid, and (iv) ethanol. The ESO, malic acid, and tannic acid are present in a mass ratio from about 1:0.1:0.1 to about 1:10:10.

Provided is a method of making the adhesive composition, which method comprises:
i) heating an epoxidized oil (EO);
ii) mixing a phenolic compound with the epoxidized oil of step (i) to obtain a solution, wherein the phenolic compound is optionally in the form of a solution in a solvent;
iii) adding a nucleophile to the solution of step (ii) and heating said solution; and
iv) cooling the solution to room temperature, whereupon the adhesive composition is obtained.

The EO can be heated at a temperature of about 70° C. to about 90° C. to obtain the desired viscosity. The solution of step (iii) can be heated at the temperature of about 70° C. to about 90° C. The solution can be heated overnight and cooled to room temperature to obtain the adhesive composition.

The adhesive composition can be used to adhere substrates. The substrates can be exposed to dry, wet, moist, or underwater conditions. The substrates can be selected from metal substrates such as steel or aluminium, wood, plastic such as polyvinyl chloride (PVC) or polytetrafluoroethylene (Teflon), ceramic, or a combination thereof. In some embodiments, the metal substrate can be steel or aluminium.

Provided is a method of using the adhesive composition, which method comprises applying the adhesive composition to at least a first substrate, which is to be adhered to at least a second substrate, and adhering the at least first substrate and the at least second substrate to each other. The method further comprise applying the adhesive composition to the at least second substrate prior to adhering the at least first substrate and the at least second substrate. At least one of the substrates is exposed to dry, moist, wet, or underwater conditions.

### BRIEF DESCRIPTION OF THE DRAWINGS

The present disclosure will be more readily understood from the detailed description of embodiments presented below, considered in conjunction with the attached drawings of which:

FIG. 1 shows an adhesion as a function of varied ratios between the components epoxidized soy oil, glycerol, and tannic acid (soy-gly-tan). The substrates were untreated aluminum and cured at 180° C. for 24 hours.

FIG. 2 shows an adhesion as a function of varied ratios between the components epoxidized soy oil, malic acid, and tannic acid (soy-mal-tan). The substrates were untreated aluminum and cured at 180° C. for 24 hours.

FIG. 3 shows the adhesion of soy-mal-tan over time when cured at 180° C. and with polished steel substrates.

FIG. 4A shows the adhesion values for soy-mal-tan when compared against commercial adhesives with polished steel substrates.

FIG. 4B shows the adhesion values for soy-mal-tan when compared against commercial adhesives with sandblasted aluminum substrates.

FIG. 5 shows the adhesion values for soy-mal-tan when compared against commercial adhesives with polyvinyl chloride (PVC) substrates. The bar for Super Glue shows the force at which the PVC substrates broke.

FIG. 6 shows the adhesion performance of a sustainably sourced adhesive. A) illustrates the lap shear bonding of soy-mal-tan with sandblasted steel, B) illustrates the lap shear bonding of soy-mal-tan with polished aluminum, C) illustrates the lap shear bonding of soy-mal-tan with teflon, and D) illustrates lap shear bonding of soy-mal-tan with pine wood substrates. In each case, comparisons are made to commercial glues, which were cured according to instructions from the manufacturers. Bonds with soy-mal-tan and metal substrates were cured for 6 hours at 180° C., whereas teflon substrates used a 24-hour cure, also at 180° C. Curing for wood bonding was at 120° C. for three days. Panel E) shows how the use of soy-mal-tan caused the failure of the wood substrates prior to the breaking of the adhesive bond.

FIG. 7 shows scanning electron microscopy (SEM) images of adhesives after being pulled to failure. A commercial epoxy shows clean fracture and distinct regions of adhesive versus substrate. The soy-mal-tan material shows more complex failure, with stress lines, indicative of ductile behavior. Both substrates were polished steel. The soy-mal-tan adhesive was cured at 180° C. for 6 hours.

FIG. 8 shows the appearance of the soy-mal-tan system at different stages. A) Epoxidized soy oil, malic acid, and tannic acid upon initial mixing at room temperature. B) Soy-mal-tan after 24-hour reaction time at 70° C. The adhesive precursor was maintained at 70° C. and viscous but flowing. C) After the 24-hour reaction at 70° C., cooling to room temperature brought about an increase in viscosity. D) Hardening after a 24-hour cure at 180° C. and scraped off substrates.

FIG. 9 shows the characterization of soy-mal-tan. A) illustrates 1H NMR spectra in DMSO-d6 of the components, combinations, and the final formulation. B) illustrates 13C NMR spectra in DMSO-d6 of malic acid, selected reaction products, and soy-mal-tan. Diethyl malate is provided for an ester reference. C) illustrates infrared spectra of the carbonyl (C—O) region. D) illustrates infrared spectra of the acid (CO—OH) region.

FIG. 10A) shows the water resistance of soy-mal-tan to artificial sea water. Bonded pairs of polished aluminum substrates, with 1.2×1.2 cm overlap area, were cured in the air for 24 hours at 70° C. or 6 hours at 180° C. and then submerged underwater for varied periods of time. The x-axis is a log plot in minutes, labeled in hours for clarity. B) shows a pickup truck rocker panel with pieces of steel bonded together using rivets (top) and soy-mal-tan adhesive (bottom). Each assembly is held up by a string (beige) on the top. A 15-pound weight is hanging from the bottom.

FIG. 11 shows testing the resistance of soy-mal-tan adhesion to boiling water. The substrates used were polished aluminum.

### DETAILED DESCRIPTION

For the purposes of promoting an understanding of the principles of the present disclosure, reference will now be made to the embodiments illustrated in the drawings, and specific language will be used to describe the same. No limitation of scope is intended by the description of these embodiments. On the contrary, this disclosure is intended to cover alternatives, modifications, and equivalents as may be included within the spirit and scope of this application as defined by the appended claims.

The terms “adhesive” and “adhesive composition” are used interchangeably.

The term “phenolic compound” refers to a compound with a chemical structure that has at least one aromatic ring with one or more hydroxyl groups attached to the aromatic ring. The “phenolic compound” may also include polyphenol, which may have more than one aromatic ring with one or more hydroxyl groups attached to the more than one aromatic rings.

It is well known that epoxy glues are formed by the reaction of multifunctional epoxy-containing compounds, such as bisphenol A diglycidyl ether, with polyamines, including triethylenetetramine. Nucleophilic amines open the three-membered epoxy rings and generate C—N bonds to form extensively cross-linked matrices. Soy oil, one of the most widely available sources of renewable organics, is an alternative to epoxies. A simple reaction of soy oil with acid and hydrogen peroxide yields epoxidized soy oil. It is a low-cost bio-based material that is readily available at large scales. But epoxidized soy oil on reaction with polyamines yields only viscous oils, which are not good for adhesion and hence can not be a straight-up replacement for bisphenol A diglycidyl ether.

Marine mussels stick themselves to rocks with proteins containing 3,4-dihydroxyphenylalanine (DOPA). These DOPA groups enable proteins to bond surfaces via hydrogen bonds and metal chelation, amongst several other interactions. Furthermore, oxidation of these pendant dihydroxyphenyl (i.e., catechol) groups brings about cross-linking to provide cohesive interactions. Thus, when catechol-like chemistry is included in the adhesive formulations, epoxidized soy oil can be transformed into strong adhesives.

In view of the above, the present disclosure provides an adhesive composition comprising (i) an epoxidized oil (EO), (ii) a nucleophile, and (iii) a phenolic compound. In embodiments thereof, the adhesive composition consists essentially of, or consists of, (i)-(iii).

This adhesive composition can be a high-strength adhesive comprising components derived from a sustainable biological source. The biological source can be an agricultural feedstock that is low-cost, readily available on a large scale, and easily recycled.

The epoxidized oil can be any suitable epoxidized oil obtained from a sustainable source. The sustainable source can be a plant or a vegetable. In some embodiments, the epoxidized oil is epoxidized soy oil (ESO).

The ESO can be made from soy oil. Soy oil can be obtained from soybean plants, whereas nucleophiles and phenolic compounds can be obtained from other sustainable natural sources. Thus, the adhesive can be non-toxic and debondable.

The nucleophile is any suitable multifunctional bio-based nucleophile that can open an epoxy ring. Examples of nucleophiles include, but are not limited to, compounds comprising a moiety selected from the group consisting of an acid, an alcohol, an amine, and a thiol. In some embodiments, the nucleophile is selected from fumaric acid, glycerol, malic acid, succinic acid, or a combination thereof. In exemplary embodiments, the nucleophile is malic acid.

The phenolic compound can be selected from catechol, gallic acid, gallol, lignin, tannic acid, or a combination thereof. The phenolic compounds, for example, tannic acid comprise abundant reactive terminal phenolic hydroxyl groups with a hyperbranched aromatic/alicyclic polyester core, which can form highly cross-linked networks with ESO, which has a highly active epoxy group. In exemplary embodiments, the phenolic compound is tannic acid.

The adhesive composition can further comprise a solvent. In some embodiments, the adhesive composition can comprise the solvent when the phenolic compound used is tannic acid. Thus, the use of the solvent in adhesive composition can be optional. In embodiments thereof, the adhesive composition can further consist essentially of (or can further consist of) a solvent.

Any suitable solvent that solubilizes tannic acid can be used. Examples of the solvent include, but are not limited to, alcohols such as ethanol or methanol, water, chloroform, dichloromethane, dimethyl sulfoxide, and dimethyl formamide. In some embodiments, the solvent is ethanol.

In some embodiments, the EO, nucleophile, and phenolic compound can be present in a mass ratio of about 1:0.1:0.1 to about 1:10:10 (such as about 1:0.1:0.1 to 1:10:10, 1:0.1:0.1 to about 1:10:10 or 1:0.1:0.1 to 1:10:10) In some embodiments, the EO, nucleophile, and phenolic compound can present in the mass ratio of about 1:0.3:0.3 to about 1:0.6:0.6 (such as about 1:0.3:0.3 to 1:0.6:0.6, 1:0.3:0.3 to about 1:0.6:0.6 or 1:0.3:0.3 to 1:0.6:0.6). Desirably, the EO, nucleophile, and phenolic compound can present in the mass ratio of about 1:0.4:0.5 (such as 1:0.4:0.5).

In some embodiments, provided is a highest-strength adhesive composition comprising (i) an ESO (ii) a malic acid, and (iii) a tannic acid (“soy-mal-tan”). The ESO, malic acid, and tannic acid can present in a mass ratio of about 1:0.1:0.1 to about 1:10:10 (such as about 1:0.1:0.1 to 1:10:10, 1:0.1:0.1 to about 1:10:10 or 1:0.1:0.1 to 1:10:10). In some embodiments, ESO, malic acid, and tannic acid can present in a mass ratio of about 1:0.3:0.3 to about 1:0.6:0.6 (such as about 1:0.3:0.3 to 1:0.6:0.6, 1:0.3:0.3 to about 1:0.6:0.6 or 1:0.3:0.3 to 1:0.6:0.6). Desirably, ESO, malic acid, and tannic acid can present in the mass ratio of about 1:0.4:0.5 (such as 1:0.4:0.5). The adhesive composition can further comprise an organic solvent, such as alcohol. In some embodiments, the alcohol is ethanol or methanol. The amount of organic solvent, such as ethanol, present is about 0.4 g (such as 0.4 g) for each gram of soy-mal-tan. In embodiments thereof, the adhesive composition consists essentially of, or consists of, soy-mal-tan and ethanol.

The epoxidized oil, the nucleophile, and the phenolic compound can form covalent bonds and highly cross-linked matrices, which contribute to high-strength adhesion.

The adhesive composition can be manufactured by reacting the EO, nucleophile, and phenolic compound. The ESO, nucleophile, (e.g., malic acid) and phenolic compound (e.g., tannic acid) can be reacted together to obtain the adhesive composition (e.g., soy-mal-tan). The ESO, malic acid, and tannic acid can be represented by the structures as shown below. In some embodiments, the reaction of the three components together can yield a high-strength and sustainably sourced adhesive.

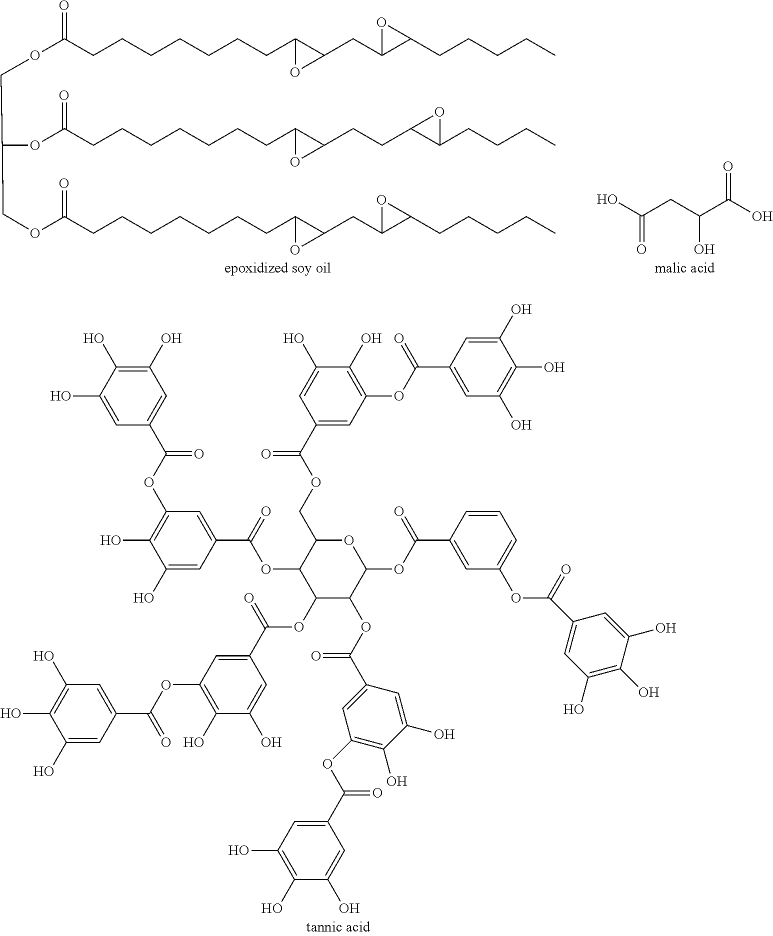 [SMILES: CCCCCC1OC1CC1OC1CCCCCCCC(=O)OCC(COC(=O)CCCCCCCC1OC1CC1OC1CCCCC)OC(=O)CCCCCCCC1OC1CCC1OC1CCCC ; O=C(O)CC(O)C(=O)O ; O=C(OCC1OC(OC(=O)c2cccc(OC(=O)c3cc(O)c(O)c(O)c3)c2)C(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)C1OC(=O)c1cc(O)c(O)c(OC(=O)c2cc(O)c(O)c(O)c2)c1)c1cc(O)c(O)c(OC(=O)c2cc(O)c(O)c(O)c2)c1]

Provided is a method of making the adhesive composition, which method comprises:
i) heating an epoxidized oil (EO);
ii) mixing a phenolic compound with the epoxidized oil of step (i) to obtain a solution, wherein the phenolic compound is optionally in the form of a solution in a solvent;
iii) adding a nucleophile to the solution of step (ii) and heating said solution; and
iv) cooling the solution to room temperature,
   whereuopn the adhesive composition is obtained.

The reaction can be carried out at about 20° C. to about 90° C., such as about 20° C. to 90° C., 20° C. to about 90° C., or 20° C. to 90° C. Desirably the reaction is carried out at about 20° C. to about 70° C., such as about 20° C. to 70° C., 20° C. to about 70° C., or 20° C. to 70° C. The reaction can be carried out for about 6 hours to about 24 hours, such as about 6 hours to 24 hours, 6 hours to about 24 hours, or 6 hours to 24 hours. This simple mixing and heating process can easily be performed on a large scale.

Any suitable solvent that solubilizes tannic acid can be used. Examples of the solvent include, but are not limited to, alcohols such as ethanol or methanol, water, chloroform, dichloromethane, dimethyl sulfoxide, and dimethyl formamide. In some embodiments, the solvent is ethanol.

In some embodiments, the EO can be heated at a temperature of about 70° C. to about 90° C. to decrease the viscosity. The reaction at 70° C. for 24 hours yields the amber-colored flowing gel adhesive composition for application between substrates. The heated material can be placed between substrates and cured to form the final adhesive. The adhesive can be cured at about 20° C. to about 180° C. such as about 20° C. to 180° C., 20° C. to about 180° C., or 20° C. to 180° C. for about 1 hour to about 24 hours, such as about 1 hour to 24 hours, 1 hour to about 24 hours, or 1 hour to 24 hours. A high bond strength can be achieved for the adhesive when cured at about 180° C. for about 24 hours. After curing (180° C., 24 hours), the adhesive can become a hard, blackish solid.

Further provided is a method of using the adhesive composition, which method comprises applying the adhesive composition to at least a first substrate, which is to be adhered to at least a second substrate, and adhering at least the first substrate and the at least the second substrate to each other. The method further comprises applying the adhesive composition to the at least second substrate prior to adhering the at least first substrate and the at least second substrate.

Adhesive composition can be used when the first substrate and/or the second substrate are exposed to dry, moist, wet, or underwater conditions.

The substrate used for the adhesion can be selected from metal such as steel or aluminium, wood, plastic such as polyvinyl chloride (PVC) or polytetrafluoroethylene (Teflon), ceramic, or any combination thereof. The metal substrate can be polished or sandblasted. In some embodiments, the metal substrate can be steel or aluminium.

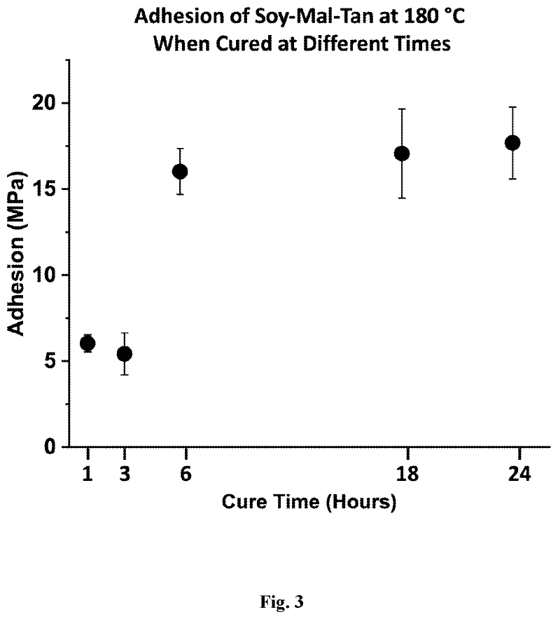

FIG. 3 shows the curing of the adhesive placed between two pieces of steel and cured at 180° C. for 1, 3, 6, 18, or 24 hours. Bond strengths were significantly stronger at 180° C. than at either 70° C. or room temperature (Table 1). The 24-hour cure time provided the strongest bonds, although 6 hours of cure were close, generating a lower carbon footprint from heating.

TABLE 1
shows the adhesion of soy-mal-tan to different substrates and cure conditions.

| | | Hair | | | | |
|---|---|---|---|---|---|---|
| | Room | Dryer | Heat Gun | 70° C | 180° C. | 180° C |
| | Temperature | (~65° C., | (~200° C., | (24 | (6 | (24 |
| Substrate | (24 hours) | 5 min) | 5 min) | hours) | hours) | hours) |
| Polished Steel | 0.7 ± 0.1 | 1.2 ± 0.5 | 4.1 ± 0.4 | 2.5 ± 0.9 | 16 ± 1 | 18 ± 2 |
| Polished | 0.8 ± 0.2 | 1 ± 1 | 3.2 ± 1.1 | 2.4 ± 0.9 | 13 ± 1 | 15 ± 2 |
| Aluminum | | | | | | |
| Sandblasted Steel | 0.7 ± 0.3 | 1.5 ± 0.4 | 3.9 ± 0.9 | 1.9 ± 0.7 | 13 ± 2 | 14 ± 1 |
| Sandblasted | 1.5 ± 0.3 | 0.3 ± 0.3 | 1.6 ± 0.5 | 2.1 ± 0.6 | 10 ± 1 | 10 ± 1 |
| Aluminum | | | | | | |

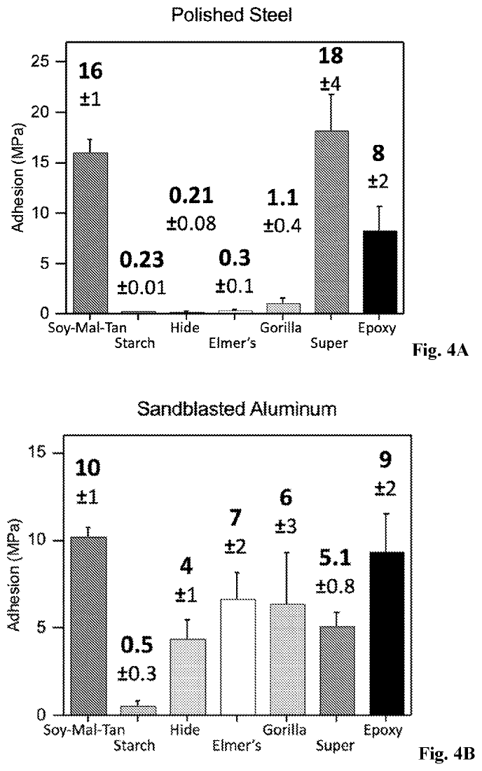

The bonding characteristics of the adhesives were examined with aluminium and steel substrates. FIGS. 4A and 4B show that bonding was often well into structural strengths (e.g., >1 MPa), ranging from 10±1 MPa for sandblasted aluminum up to 16±1 MPa for polished steel. The structural strengths for polished aluminum and sandblasted steel were about ˜13 MPa. Adhesive controls containing only two components were substantially weaker or did not bond at all. Epoxidized soy oil with malic acid (no tannic acid) adhered at 1.9±0.4 MPa. Malic acid with tannic acid (no epoxidized soy oil) formed a hard solid without any ability to bond. Epoxidized soy oil and tannic acid (no malic acid) never cured to a solid.

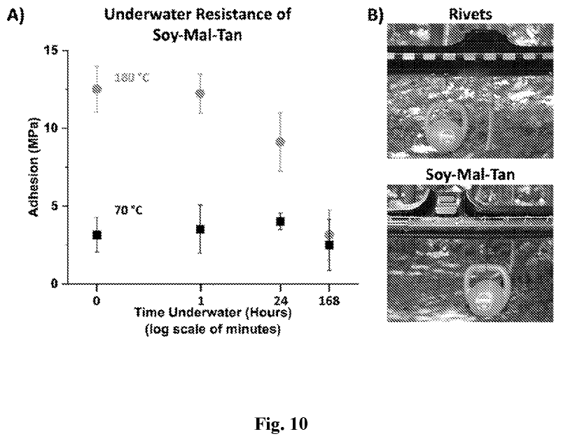

A degree of water resistance is required to ensure that products remain intact when faced with difficult conditions. However, the water resistance of current industrial adhesives impedes debonding, recycling of components, and degradation in landfills. Water resistance studies were carried out to see debonding of the adhesive. The water used for underwater environment testing was sea water. The substrates can be submerged underwater during the application of adhesive or after the application. Water resistance studies showed gradual debonding over the course when the substrate was submerged for a week. FIG. 10 shows that, when the substrate was submerged underwater for 24 hours, soy-mal-tan maintained ˜75-100% of initial dry bond strength. After one week underwater, ˜26-78% of the bonding persisted.

The adhesive composition can be used as a high-strength adhesive for automotive, construction, and electronic applications. The adhesive composition can be useful for adhering parts of a vehicle, wherein the vehicle can be automotive.

Lightweighting of automobiles and trucks can be an example of where the adhesive can provide additional environmental benefits. A change from heavy rivets and welds toward adhesive bonding can decrease vehicle weights and increase fuel efficiency. FIG. 10 shows how a pickup truck rocker panel could be riveted to sections of steel bars to represent a vehicle frame and shows soy-mal-tan adhesive performance for joining the substrates. The adhesive was cured with a heat gun for five minutes. By replacing 36.9 grams of steel rivets with 0.9 grams of glue, the bonding agent mass in these assemblies decreased by ˜97%.

Sustainability goals for materials can include both having bio-based starting components as well as low levels of energy input. The soy-mal-tan was cured at 180° C. for 6 hours. For comparison, epoxies are cured using a wide range of conditions. It was observed that epoxies do not achieve a complete cure if only kept at room temperature. Automotive, construction, and electronic applications comprise a large percentage of epoxy consumption and common conditions may use 120-180° C. for 30 minutes.

### EXAMPLES

### Materials

Epoxidized soybean oil (ESO) 450 lb was purchased from the chemical company. DL-malic acid, fumaric acid, succinic acid, glycerol, tannic acid, gallic acid, and lignin were all purchased from Sigma-Aldrich and were used without modification. Pyrocatechol was purchased from Acros and used without modification.

### Example 1

### Synthesis of Epoxidized Soy Oil-Malic Acid-Tannic Acid (Soy-Mal-Tan)

1.0 g of ESO was added to a 20 mL glass vial with a magnetic stir bar and heated at 70° C. in an oil bath. After sufficient heating to decrease viscosity, 1 mL of a 0.5 g/mL tannic acid/EtOH solution was added to the ESO and allowed to mix for ˜5 minutes. 0.4 g of malic acid was then added slowly to the solution until dissolved fully. The reaction was heated overnight and taken out of the oil bath, and cooled to room temperature. At this point, the adhesive took on an amber color and was free-flowing while still warm and gradually hardened until at room temperature.

### Example 2

### Synthesis of Epoxidized Soy Oil-Glycerol-Tannic Acid (Soy-Gly-Tan)

Soy-Gal-Tan was prepared using the procedure of Example 1 using epoxidized soy oil, glycerol, and tannic acid.

### Preparation of Adherends

### Metals

The steel used was low carbon and conforming to the ASTM A109 standard. Aluminum was of the 6061 alloy and conforming to the ASTM B209 standard.

### Polished Substrates

Polished ASTM aluminum and stainless steel adherends (12 mm×3.175 mm×89 mm) were polished using various metal polishing bars and a polishing wheel. Stainless steel adherends were polished sequentially with a black emery bar and then a general green bar. Polished aluminum was prepared using only a brown tripoli bar due to the softness of aluminum. After polishing, excess grease was wiped away, and all substrates were cleaned using a progressive solvent system comprised of hexanes, acetone, MeOH, and finally, DI water. The substrates were allowed to dry overnight before use.

### Sandblasted Substrates

ASTM aluminum and stainless steel adherends were placed in a sandblast cabinet and prepared using an abrasive comprised of fine glass bead media. The glass beads were used to create a rough surface on the substrates for a direct comparison of how soy-mal-tan performs on smooth or rough interfaces.

### Low Energy Plastics

Polyvinyl chloride (PVC) and polytetrafluoroethylene (Teflon) substrates were cut into (12 mm×12 mm×89 mm) pieces. No special preparation for either material was necessary before use in adhesive testing.

### Wood

Pieces of pine were cut to 12 mm×12 mm×89 mm dimensions. Surfaces of pine substrates were treated briefly with 60 grit sandpaper.

### Application of Adhesive on Substrates

50 mg of soy-mal-tan was added to each lap shear pair of substrates. The material was applied while it was warm due to the viscosity providing ease of use. A second adherend was placed atop the first to form an overlap area of ˜12 mm×˜12 mm. The lap-shear joint was clamped together to allow the spreading of soy-mal-tan between the substrates. After cooling to room temperature, the material hardened between substrates. These joints were placed into an oven at 180° C. for 6 hours for the high-energy substrates and 24 hours with Teflon. The PVC samples were placed in an oven at a lower temperature, 110° C., for 24 hours, owing to the melting point of this plastic. After curing at 180° C., soy-mal-tan appeared dark brown/black in color and was harder than after the initial reaction.

### Adhesion Testing

Adhesive strength was initially determined using an Instron 5544 fitted with a 2 kN load cell. Samples that would breach the load cell capacity were measured on an MTS Insight materials testing instrument with a 10 kN load cell or an Instron 34TM-30 instrument with a 30 kN load cell. Samples for both the Instron and MTS were placed in the instrument using two steel crossbars (e.g., drill bit blanks) to hold each adherend in place. The crossbars were pulled apart to stress the joints at a pull rate of 2 mm/min. The maximum force applied on the joints prior to failure was recorded in Newtons (N). The resulting adhesive strength in units of megapascals (MPa) was calculated by dividing this maximum force (N) by the joint overlap area (m2). Adhesion data reported are averages from a minimum of 10 samples, with error bars representing 90% confidence intervals. One exception here was n=5 for water resistance testing of EMT. In cases where a joint fell apart as soon as it was picked up, these samples were given a value of zero when calculated into averages.

### Artificial Sea Water

Aquacraft Marine Environment Salt mixture was used to make artificial sea water. The salts were dissolved into reverse osmosis purified water to a final salinity of 28-30 ppt measured by a refractometer. The water was aerated for at least seven days prior to use.

### Characterization

### IR Spectroscopy

Infrared spectra were obtained using a Thermo Nicolet Nexus FT-IR with a Diamond and ZnSe ATR. Data from solid samples were collected from 800-4500 cm-1 using an MCT detector. These data were analyzed to determine the disappearance of functional groups.

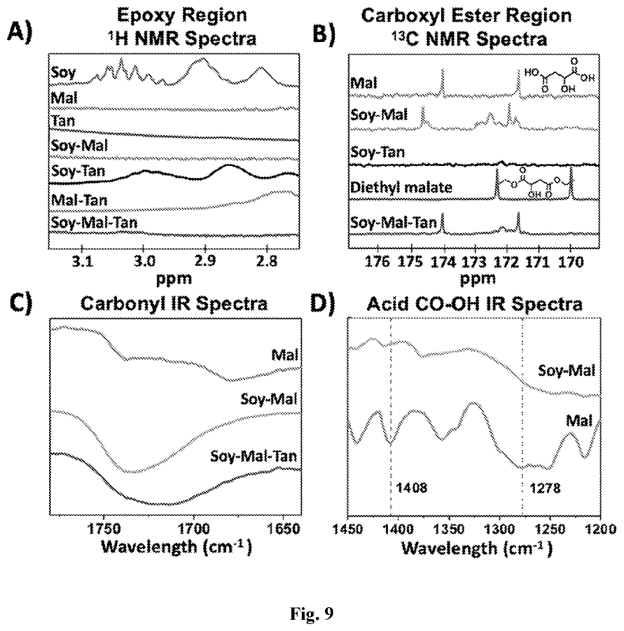

Infrared (IR) spectroscopy suggested similar bonding schemes with a potential acid-to-ester shift (˜1680 to ˜1720 cm⁻¹) upon the reaction of malic acid with epoxidized soy oil in both the presence and absence of tannic acid (FIG. 9). The carboxylic acid CO—OH bands of malic acid (1408, 1278 cm⁻¹) were also less observable after combination with epoxidized soy oil.

### NMR Spectroscopy

Samples for the NMR study were prepared using DMSO-d6 solvent and ran using an Oxford 300 MHz magnet. 1H-NMR and 13C-NMR were performed for each sample and subsequently analyzed using Mestrenova software. Peaks were isolated for individual spectra to observe the appearance or disappearance of specific groups.

According to proton nuclear magnetic resonance (1H NMR) spectroscopy, the starting epoxy groups in epoxidized soy oil disappeared upon reaction with malic acid or, to a lesser degree, with tannic acid (FIG. 9). Consumption of epoxy groups upon reaction with both malic and tannic acids was further confirmed by acid titration. Also seen in the 1H NMR spectra was the appearance of an alcohol (3.38 ppm), a characteristic result of an epoxy ring opening after a reaction with a nucleophile. The 1H NMR alcohol resonance of malic acid never changed, indicating that acid groups were the ones from malic acid reacting with the epoxies. Observing small shifts in the 13C NMR spectra indicative of aliphatic ester formation with epoxidized soil oil+malic acid+tannic acid (˜172.2 ppm) or epoxidized soil oil+malic acid (˜172.5 ppm) (FIG. 9B) supported acid+epoxy coupling. The presence of multiple broad peaks indicates the formation of a system that is cross-linked and heterogeneous.

### Differential Scanning Calorimetry (DSC)

Differential scanning calorimetry was performed using a Perkin Elmer with a 2P Intracooler and nitrogen gas purge. Each scan was programmed to run from −10 to 200° C. at 10° C./min and cooled from 200 to ˜10° C. at 40° C./min. The individual thermograms were used to calculate the glass transition temperature of each material.

Differential scanning calorimetry (DSC) showed that thermal events for epoxidized soy oil, an oil at room temperature, could be shifted to higher temperatures upon reaction with malic acid and, possibly, tannic acid. For the complete system of epoxidized soil oil+malic acid+tannic acid, a unique high-temperature thermal event was present that did not correlate to epoxidized soil oil (below room temperature), tannic acid (>200° C. alone), or malic acid.

### Epoxy Titration

Determining the epoxy groups remaining after the reaction was performed using a previously published ASTM method. Samples were titrated from a stock HBr solution until the color changed to the same as a control. Volumes to reach color change were used to calculate epoxy concentration.

### Temperatures

A standard Type T thermocouple was used to determine the approximate output temperatures of a household hair drier and laboratory heat gun.

### Microscopy

Scanning electron microscopy images were collected using an FEI Quanta 3D FEG instrument with a gallium ion beam, Everhart-Thornley detector, and a typical accelerating voltage of 5 kV.

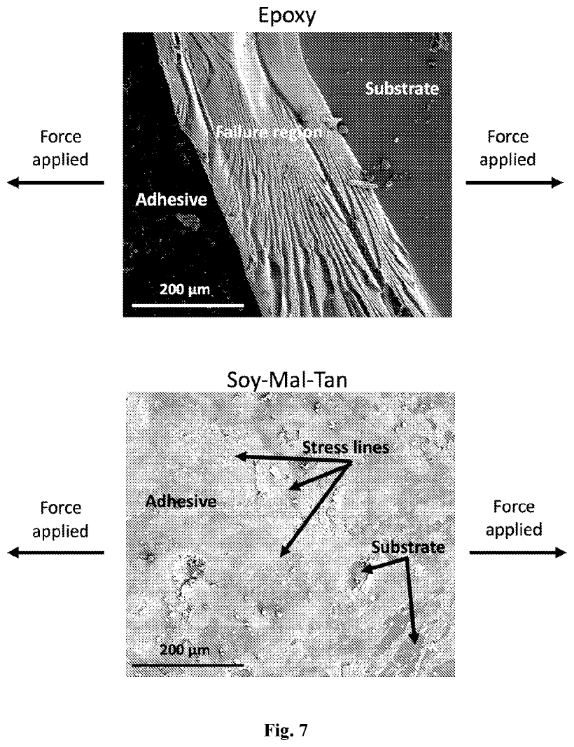

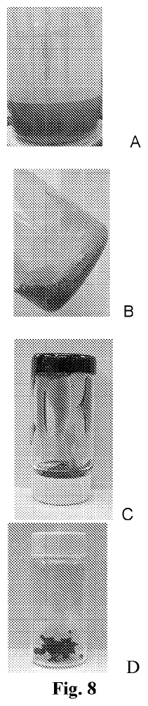

When bonded joints were pulled apart and examined by scanning electron microscopy (SEM, FIG. 7). A mixture of adhesive and cohesive failure mechanisms was found in both epoxy and soy-mal-tan samples, although differences were apparent. The epoxy showed a single, clean fracture, typical of brittleness. The SEM image of soy-mal-tan was more complex, with several stress lines providing evidence for distribution of mechanical forces throughout the bulk material. Here, too, soy-mal-tan appears to be less brittle than the epoxy.

Analogous data for the soy-mal-tan adhesive cured at room temperature, 70° C., and 180° C. displayed somewhat gradual failure, indicative of materials that are more ductile than the brittle commercial counterparts. A similar story was seen when bonded joints were pulled apart and examined by scanning electron microscopy (SEM, FIG. 7). A mixture of adhesive and cohesive failure mechanisms was found in both epoxy and soy-mal-tan samples, although differences were apparent. The epoxy showed a single, clean fracture, typical of brittleness. The SEM image of soy-mal-tan was more complex, with several stress lines providing evidence for the distribution of mechanical forces throughout the bulk material. Soy-mal-tan appeared to be less brittle than epoxy.

These analytical methods indicate that soy-mal-tan is an extensively cross-linked matrix with all three components participating in covalent bond formation. Epoxidized soy oil and malic acid coupled together via aliphatic ester bonds. Malic acid also reacted directly with tannic acid via aromatic ester bonds. Perhaps less prominent are esters formed comprised of tannic acid coupled to epoxidized soy oil.

### Lap Shear Testing

The adhesive composition was placed between two pieces of steel and cured at 180° C. for 3, 18, or 24 hours. The 24-hour cure time provided the most promising results. After cooling, joints were pulled to failure, and adhesion was quantified in maximum force at failure divided by the substrate overlap area.

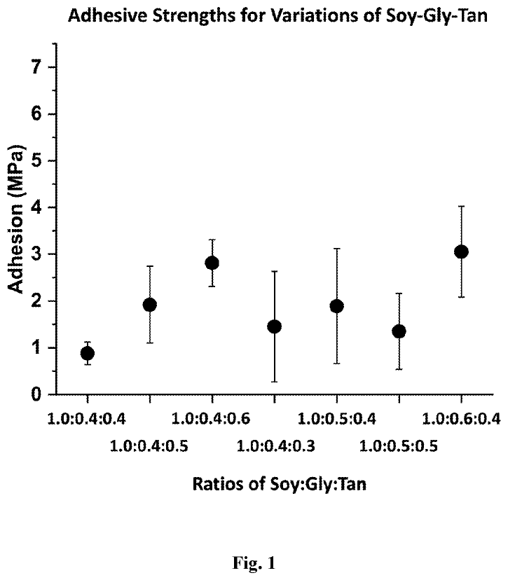

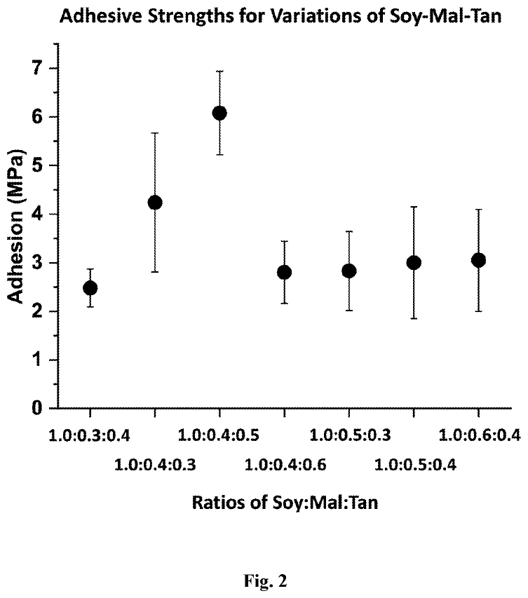

Lap shear bonding provides a practical means of obtaining large volumes of data with high reproducibility. Joints were pulled apart, and adhesion was quantified by maximum force at failure divided by the substrate overlap area. Different ratios of components were examined for epoxidized soy oil and tannic acid with either glycerol or malic acid (FIGS. 1 and 2). In the end, the highest-strength system was a 1:0.4:0.5 mass ratio of epoxidized soy oil:malic acid:tannic acid (“soy-mal-tan”). Each gram of soy-mal-tan contained ˜0.4 grams of ethanol in order to solubilize the tannic acid.

### Bonding Strengths

In order to quantify the performance of soy-mal-tan, bonding was examined with aluminum and steel, each polished or sandblasted. FIGS. 4A and 4B show that this new adhesive system bonded well into structural strengths at 10± MPa with each substrate for sanded aluminum up to 16±1 MPa for polished steel. Both polished aluminum and sandblasted steel were in between at ˜13 MPa. Controls of only two components were substantially weaker or did not bond at all. Epoxidized soy oil with malic acid (no tannic acid) adhered at 1.9±0.4 MPa. Malic acid with tannic acid (no epoxidized soy oil) formed a hard solid without any ability to bond. Epoxidized soy oil and tannic acid (no malic acid) never cured to a solid.

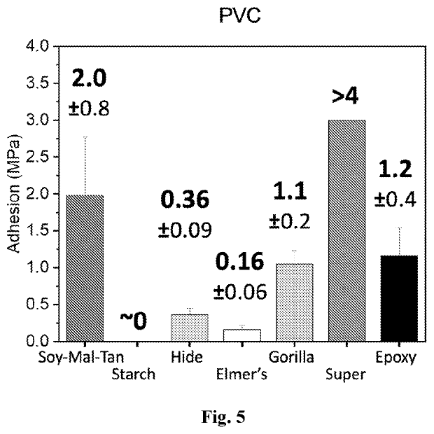

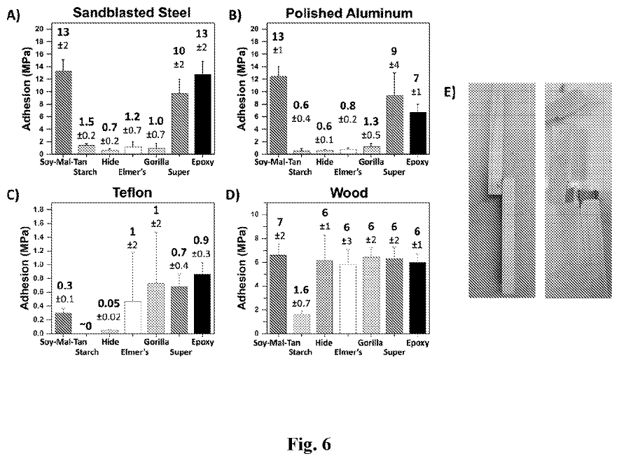

Benchmarking against commercial products is also shown in FIG. 6. Each glue was cured according to instructions from the manufacturer (e.g., time, temperature, use of clamps) and applied in the same quantity (˜50 mg) between substrates as soy-mal-tan. Two of the most widely available bio-based adhesives are starch glue and hide glue. FIG. 6A with sandblasted steel substrates shows that the bio-based products bonded at ˜0.7-1.5 MPa, about an order of magnitude less than soy-mal-tan. Amongst the petroleum-derived products, Elmer's Glue-All (a polyvinyl acetate) and Gorilla Glue (a polyurethane) were also weak with sandblasted steel at ˜1.0-1.2 MPa. The bonding here of Super Glue (a cyanoacrylate, 10±2 MPa) and epoxy (13±2 MPa) were similar to that of soy-mal-tan (13±2 MPa). When used on polished aluminum substrates, soy-mal-tan (13±1 MPa) exceeded the performance of all benchmarks including Super Glue (9±4 MPa) and epoxy (7±1 MPa), which is generally considered to be the strongest type of structural adhesive 1, 2 (FIG. 6B). FIG. 6C shows data for an example low surface energy substrate, polytetrafluoroethylene (Teflon). Here the petroleum-based glues were strongest (˜0.7-1 MPa), whereas soy-mal-tan (0.3±0.1 MPa) outperformed the commercial bio-based products (˜0-0.05 MPa). Analogous adhesion data for polished steel, sandblasted aluminum, and polyvinyl chloride (PVC) substrates are also provided in FIGS. 4A, 4B, and 5.

Wood is particularly sustainable, with plywood being one of the most widely used construction materials. Reaction (70° C., five days) and cure (120° C., three days) conditions were changed for wood. Both soy-mal-tan and most commercial systems achieved bonds exceeding the strength of wood (FIG. 6D). Intact adhesive joints and broken wood can be seen in FIG. 6E. Although the conditions used to bond wood were somewhat extreme, the observation of substrate failure indicated that less harsh parameters may be relevant to real-world use.

To explore a range of potential use conditions, soy-mal-tan (1:0.4:0.5 ratio) was applied between polished steel substrates with a room temperature cure of 24 hours. The bond strength, at 0.7±0.1 MPa, was lower than that from a 180° C. cure at 6 hours (16±1 MPa). An alternative cure using a household hair dryer (˜65° C.) for 5 minutes may have increased the bonding to 1.2±0.5 MPa. A higher temperature laboratory heat gun (˜200° C.) for 5 minutes generated 4.1±0.4 MPa. Table 1 shows similar data for polished aluminum, sandblasted aluminum, and sandblasted steel.

A degree of water resistance is required to ensure that products remain intact when faced with difficult conditions. However, the water resistance of current industrial adhesives impedes debonding, recycling of components, and degradation in landfills. The water resistance of the adhesive was tested. Bonded pairs of polished aluminum substrates were subjected to harsher conditions than many consumer products will experience. Joints with 1.2×1.2 cm overlap were cured in the air (70° C., 24 hours or 180° C., 6 hours) and then submerged under deionized water for varying times, followed by measuring of bond strengths. FIG. 10 shows that, when underwater for 24 hours, soy-mal-tan maintained ˜75-100% of initial, dry bond strength. Even after one week underwater, ˜26-78% of the bonding persisted. Analogous experiments were carried out in artificial sea water and showed generally similar results, although with slightly more rapid losses of bonding over time (FIG. 10). These extremes of deionized to artificial sea waters span most aqueous conditions and indicate the potential role of salt in debonding to be minor.

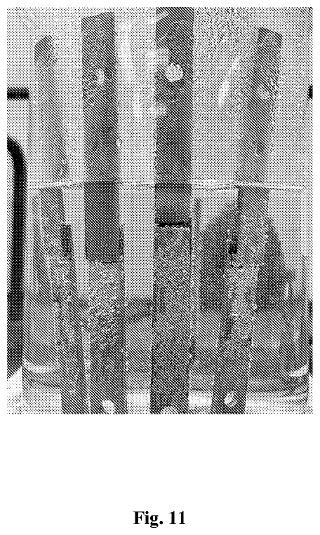

A control experiment showed that the performance of epoxy was also influenced by salt water. Over the course of a week underwater, the average strengths of joints did not change significantly; however, error bars increased dramatically. Epoxies are known to swell in water. Here water exposure made the epoxy more flexible, and bubbles began to form, indicating that water was entering the material. Polished aluminum substrates, bonded together with soy-mal-tan and cured at 180° C. for 24 hours, were subjected to harsh conditions of submersion into boiling deionized water for 4 hours (FIG. 11). Adhesion of these samples was at 3±2 MPa, compared to 15±1 MPa for control samples left on a benchtop.

Industrial strength needs for adhesive performance span a wide range with, for example, packaging being not particularly challenging at 0.5-4 MPa. At the other extreme are the high requirements of automotive and aerospace structures at 5-30 MPa. Making direct numerical comparisons can be tricky, with variables including changes to joint configurations, substrates, environments, and use conditions. Nonetheless, soy-mal tan bonded metals at ˜10-16 MPa and are potentially within the needs of the most demanding applications.

Lightweighting of automobiles and trucks is an example of where new materials may provide additional environmental benefits. A change from heavy rivets and welds toward adhesive bonding can decrease vehicle weights and increase fuel efficiency. FIG. 4B shows how a pickup truck rocker panel could be riveted to sections of steel bars to represent a vehicle frame. Also shown is an alternative using soy-mal-tan for joining the substrates. Here the adhesive was cured with a heat gun for five minutes. By replacing 36.9 grams of steel rivets with 0.9 grams of glue, the bonding agent mass in these assemblies decreased by ˜97%.

### Co₂ Emission Data

Producing and curing one ton of epoxy was estimated to generate ˜5.8 tons of CO₂ emissions. Production of one ton of soy-mal-tan consumed ˜11 tons of CO₂, and curing of one ton of soy-mal-tan emitted ˜6.6 tons of CO₂. Thus, the estimated production and use for one ton of soy-mal-tan may absorb roughly 4.4 tons of CO₂.

In addition, any of the embodiments described in the following clause list are considered to be part of the invention.
A. An adhesive composition comprising (i) an epoxidized oil (EO), (ii) a nucleophile, and (iii) a phenolic compound.
B. The adhesive composition of clause A, wherein the epoxidized oil is epoxidized soy oil.
C. The adhesive composition of clause A, wherein the nucleophile is a compound comprising a moiety selected from the group consisting of an acid, an alcohol, an amine, and a thiol.
D. The adhesive composition of clause C, wherein the nucleophile is selected from fumaric acid, glycerol, malic acid, succinic acid, or a combination thereof.
E. The adhesive composition of clause D, wherein the nucleophile is malic acid.
F. The adhesive composition of clause A, wherein the phenolic compound is selected from catechol, gallic acid, gallol, lignin, tannic acid, or a combination thereof.
G. The adhesive composition of clause F, wherein the phenolic compound is tannic acid.
H. The adhesive composition of clause A or G, wherein the composition further comprises a solvent.
I. The adhesive composition of clause H, wherein the solvent is selected from alcohol, water, chloroform, dichloromethane, dimethyl sulfoxide, and dimethyl formamide.
J. The adhesive composition of clause I, wherein the solvent is ethanol or methanol.
K. The adhesive composition of clause A, wherein the EO, nucleophile, and phenolic compound are present in a mass ratio from about 1:0.1:0.1 to about 1:10:10.
L. An adhesive composition consisting essentially of (i) an epoxidized soy oil (ESO), (ii) malic acid, (iii) tannic acid, and (iv) ethanol.
M. The adhesive composition of clause L, wherein the ESO, malic acid, and tannic acid are present in a mass ratio from about 1:0.1:0.1 to about 1:10:10.
N. An adhered substrate comprising the adhesive composition of any one of clause A-M.
O. The adhered substrate of clause N, wherein the substrate is exposed to dry, wet, moist, or underwater conditions.
P. The adhered substrate of clause O, wherein the substrate is metal, wood, plastic, ceramic, or any combination thereof.
Q. The adhered substrate of clause P, wherein the metal substrate is steel or aluminium.
R. A method of manufacturing the adhesive composition of clause A or L, which method comprises:
   i) heating an epoxidized oil (EO);
   ii) mixing a phenolic compound with the epoxidized oil of step (i) to obtain a solution, wherein the phenolic compound is optionally in the form of a solution in a solvent;
   iii) adding a nucleophile to the solution of step (ii) and heating said solution; and
   iv) cooling the solution to room temperature,
   whereuopn the adhesive composition is obtained.
S. The method of clause R, wherein the EO is epoxidized soy oil.
T. The method of clause R, wherein the EO and solution of step (iii) are heated at a temperature of about 70° C. to about 90° C.
U. The method of clause R, wherein the solvent is selected from alcohol, water, chloroform, dichloromethane, dimethyl sulfoxide, and dimethyl formamide.
V. The method of clause R, wherein the nucleophile is a compound comprising a moiety selected from the group consisting of an acid, an alcohol, an amine, and a thiol.
W. The method of clause V, wherein the nucleophile is selected from fumaric acid, glycerol, malic acid, succinic acid, or a combination thereof.
X. The method of clause W, wherein the nucleophile is malic acid.
Y. The method of clause R, wherein the phenolic compound is selected from catechol, gallic acid, gallol, lignin, tannic acid, or a combination thereof.
Z. The method of clause Y, wherein the phenolic compound is tannic acid.
A′. A method of using the adhesive composition of any one of clause A-M, which method comprises applying the adhesive composition to at least a first substrate, which is to be adhered to at least a second substrate, and adhering the at least first substrate and the at least second substrate to each other.
B′. The method of clause A′, which further comprises applying the adhesive composition to the at least second substrate prior to adhering the at least first substrate and the at least second substrate.
C′. The method of clause A′ or B′, wherein the at least first substrate and/or the at least second substrate are exposed to dry, moist, wet, or underwater conditions.
D′. The method of clause A′ or B′, wherein the at least first substrate and/or the at least second substrate is metal, wood, plastic, ceramic, or any combination thereof.
E′. The method of clause D′, wherein the metal is steel or aluminum.

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid the reading of the document and is not to be interpreted as limiting. Further, information that is relevant to a section heading may occur within or outside of that particular section. The terms “including” and “having” are defined as comprising (i.e., open language).

Furthermore, all publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

Those skilled in the art will recognize that numerous modifications can be made to the specific implementations described above. The implementations should not be limited to the particular limitations described. Other implementations may be possible.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

1. An adhesive composition comprising (i) an epoxidized oil (EO), (ii) a nucleophile, and (iii) a phenolic compound.

2. The adhesive composition of claim 1, wherein the epoxidized oil is epoxidized soy oil; and/or
the nucleophile is a compound comprising a moiety selected from the group consisting of an acid, an alcohol, an amine, and a thiol.

3. (canceled)

4. The adhesive composition of claim 2, wherein the nucleophile is selected from fumaric acid, glycerol, malic acid, succinic acid, or a combination thereof.

5. (canceled)

6. The adhesive composition of claim 1, wherein the phenolic compound is selected from catechol, gallic acid, gallol, lignin, tannic acid, or a combination thereof.

7. (canceled)

8. The adhesive composition of claim 1, wherein the composition further comprises a solvent.

9. The adhesive composition of claim 8, wherein the solvent is selected from alcohol, water, chloroform, dichloromethane, dimethyl sulfoxide, and dimethyl formamide.

10. The adhesive composition of claim 9, wherein the solvent is ethanol or methanol.

11. The adhesive composition of claim 1, wherein the EO, nucleophile, and phenolic compound are present in a mass ratio from about 1:0.1:0.1 to about 1:10:10.

12. The adhesive composition of claim 1 consisting essentially of (i) an epoxidized soy oil (ESO), (ii) malic acid, (iii) tannic acid, and (iv) ethanol.

13. The adhesive composition of claim 12, wherein the ESO, malic acid, and tannic acid are present in a mass ratio from about 1:0.1:0.1 to about 1:10:10.

14. An adhered substrate comprising the adhesive composition of claim 1.

15. The adhered substrate of claim 14, wherein the substrate is exposed to dry, wet, moist, or underwater conditions.

16. The adhered substrate of claim 14, wherein the substrate is metal, wood, plastic, ceramic, or any combination thereof.

17. The adhered substrate of claim 16, wherein the metal substrate is steel or aluminum.

18. A method of manufacturing the adhesive composition of claim 1, which method comprises:
i) heating an epoxidized oil (EO);
ii) mixing a phenolic compound with the epoxidized oil of step (i) to obtain a solution, wherein the phenolic compound is optionally in the form of a solution in a solvent;
iii) adding a nucleophile to the solution of step (ii) and heating said solution; and
iv) cooling the solution to room temperature, whereuopn the adhesive composition is obtained.

19. The method of claim 18, wherein the EO is epoxidized soy oil.

20. The method of claim 18, wherein the EO and solution of step (iii) are heated at a temperature of about 70° C. to about 90° C.

21. The method of claim 18, wherein the solvent is selected from alcohol, water, chloroform, dichloromethane, dimethyl sulfoxide, and dimethyl formamide.

22. The method of claim 18, wherein the nucleophile is a compound comprising a moiety selected from the group consisting of an acid, an alcohol, an amine, and a thiol.

23. The method of claim 22, wherein the nucleophile is selected from fumaric acid, glycerol, malic acid, succinic acid, or a combination thereof; and/or
the phenolic compound is selected from catechol, gallic acid, lignin, tannic acid, or a combination thereof.

24-31. (canceled)
